(19) United States
(12) Patent Application Publication
(10) Pub. No.: US 2008/0066848 A1
(43) Pub. Date: Mar. 20, 2008

(54) METHOD OF PRODUCING ARTIFICIAL LEATHER AND ARTIFICIAL LEATHER

(75) Inventors: Chung Chih FENG, Kaohsiung City (TW); I Peng Yao, Kaohsiung City (TW); Chun Wei Wu, Kaohsiung County (TW); Kun Lin Chiang, Kaohsiung County (TW); Yung Ching Huang, Kaohsiung City (TW)

Correspondence Address: SUGHRUE MION, PLLC, 2100 PENNSYLVANIA AVENUE, N.W., SUITE 800, WASHINGTON, DC, 20037, US

(73) Assignee: San Fang Chemical Industry Co., Ltd.

(21) Appl. No.: 11/943,656

(22) Filed: Nov. 21, 2007

Related U.S. Application Data
(62) Division of application No. 11/447,140, filed on Jun. 6, 2006.

(51) Int. Cl. D06N 3/00; B32B 5/20

(52) U.S. Cl. 156/78

(57) ABSTRACT

The present invention relates to a method of producing artificial leather, comprising steps of: (a) providing a substrate; (b) providing a foamed polyurethane dispersion, wherein the polyurethane dispersion has a solid content of about 40% to about 60% and a void content of about 0.01% to about 80%; (c) coating the substrate with a layer of the foamed polyurethane dispersion; and (d) drying the substrate and the layer of the foamed polyurethane dispersion for obtaining the artificial leather. Artificial leather is also provided in the present invention.

### BACKGROUND OF THE INVENTION

1. Field of the Invention

The present invention relates to a method of producing artificial leather and artificial leather.

2. Description of the Related Art

Artificial leather, also known as synthetic leather, provides an economic and multi-functional way to replace natural leather. Artificial leather comprising a polyurethane formed on a substrate such as a woven fabric or non-woven fabric has been used widely for many years. Such artificial leather is required to be qualified in stain resistance, waterproofness, abrasion resistance and non-tackiness, and depending on the application, is also required to be low in the coefficient of surface friction.

Conventionally, polyurethane is formed on the substrate by wet coating. Wet coating is performed by coating a polyurethane solution onto a substrate 11 to be coated, and then drying and curing the polyurethane to form a membrane or layer 12 on the substrate (referring to FIG. 1). A conventional solvent for dissolving polyurethane to form a polyurethane solution is dimethylformamide (DMF). When curing the polyurethane solution applied on the substrate, water is usually added for replacing dimethylformamide, and polyurethane is thus cured. In conventional processes, the use of dimethylformamide results in serious environmental problems, such as air pollution and water pollution. Furthermore, dimethylformamide is proven in connection with several health dysfunctions. The quality of the polyurethane layer obtained by wet coating is not satisfied either. The thickness of the coating is limited. Holes formed inside the layer of polyurethane on the substrate are about in a drop shape, and its size is quite large and with a length of about 250 to about 350 μm and a width of about 150 to about 320 μm. Hole distribution is also uneven; wherein larger holes are present in a part near the surface of the substrate. Such product fails to meet the requirement of mechanical strength (such as peeling, abrasion and flexibility). The bonding strength of the conventional product manufactured by wet coating is not satisfied. Furthermore, the condition of wet coating is limited and difficult to be controlled. In addition, folding lines easily appear on the polyurethane layer of the conventional artificial leather, and the life of usage is shortened.

U.S. Pat. No. 5,460,873 discloses a novel cover material for an integrally foamed article comprising a permeable fabric and a thin layer of latex foam integrally bonded to the back surface of the fabric. The latex foam has numerous fine open cells which are formed in an internal part thereof and further finer or denser open cells which are formed in a region adjacent to its outer surface. On the outer surface of latex foam layer is formed a superficial skin. In a method for manufacturing the novel cover material of this patent, the latex material is sufficiently stirred to produce a latex foam with a density as low as possible (with a density in the range of from 20,000 cells per cm² to 70,000 cells per cm²). After drying and curing, the entire fabric is subjected to a crushing operation in which the fine open cells of the latex foam are crushed and conveniently reduced to finer or denser open cells so as to increase permeability of the latex foam. The latex foam is designed to be a gas permeable material, and the physical and chemical properties of the latex foam are quite different from those of artificial leather. For example, because the latex foam is covered with the superficial skin, the appearance and flatness of the latex foam are not strictly required. Furthermore, the cell size formed in the latex foam layer is still uneven.

Given the above, a method of producing high-quality artificial leather and the artificial leather thus produced are needed in this field. Especially, no toxic substance is used in the method of producing artificial leather or present in the artificial leather obtained therefrom.

### SUMMARY OF THE INVENTION

One object of the present invention is to provide a method of producing artificial leather, comprising steps of:
(a) providing a substrate;
(b) providing a foamed polyurethane dispersion, wherein the polyurethane dispersion has a solid content of about 40% to about 60% and a void content of about 0.01% to about 80%;
(c) coating the substrate with a layer of the foamed polyurethane dispersion; and
(d) drying the substrate and the layer of the foamed polyurethane dispersion for obtaining the artificial leather.

Another object of the present invention is to provide artificial leather comprising:
a substrate having a surface; and
a layer of foamed polyurethane formed on the surface of the substrate, comprising a plurality of holes distributed evenly therein, wherein the cross section of the holes is substantially in an ellipse shape; preferably, the holes in an ellipse shape has a diameter of about 20 μm to about 150 μm.

### BRIEF DESCRIPTION OF THE DRAWINGS

FIG. 1 illustrates the cross-section view under a scanning electron microscope of a conventional artificial leather having the holes with a length of about 250 to about 350 μm and a width of about 150 to about 320 μm.

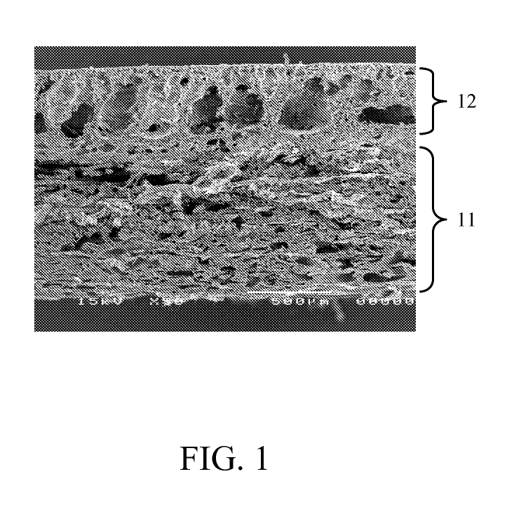

FIG. 2 illustrates the cross-section view under a scanning electron microscope of the artificial leather according to the present invention having the holes with a diameter of about 20 μm to about 150 μm.

### DETAILED DESCRIPTION OF THE INVENTION

The present invention provides a method of producing artificial leather, comprising steps of:
(a) providing a substrate;
(b) providing a foamed polyurethane dispersion, wherein the polyurethane dispersion has a solid content of about 40% to about 60% and a void content of about 0.01% to about 80%;
(c) coating the substrate with a layer of the foamed polyurethane dispersion; and
(d) drying the substrate and the layer of the foamed polyurethane dispersion for obtaining the artificial leather.

As used herein, the term “substrate” refers to a base material allowing a polyurethane layer to be formed on a surface thereof. The substrate according to the invention is a non-woven fabric or a woven fabric. As used herein, the term “fabric” refers to a single fabric or composite fabric, preferably, composite fabric. Artisans skilled in this field can choose suitable types of fabric according to the disclosure of the specification.

Preferably, the non-woven fabric used as a substrate is an ultrafine non-woven fabric, a needle-bonded fabric or a water-jet entangling fabric. The fineness of the fiber is preferably 0.01 denier to 10 denier. More preferably, the non-woven fabric is a sea-island type composite fabric comprising a sea component and an island component. The sea-island type composite fabric used in the present invention is produced by conjugate-spinning or blend-spinning two polymers in a sea-island manner. In one preferred embodiment of the invention, the sea-island type composite fabric is treated by weight reducing to reduce the amount of the sea component. The manner of weight reducing the sea component is well known to artisans skilled in this field, such as using sodium hydroxide or toluene.

Preferably, the non-woven fabric is made of at least one material selected from the group consisting of nylon, poly(ethylene terephthalate) (PET), polyolefin, polymethacrylate, polymethyl methacrylate, acrylic resin, and the mixture thereof.

In another aspect, the woven fabric is a stretch fabric, preferably, a knitted stretch fabric. In one preferred embodiment of the invention, the stretch fabric comprises stretch yarn or an elastic component.

In order to achieve better mechanical and chemical properties, the substrate is preferably pretreated by impregnating or coating the substrate with a resin solution such as an elastomer solution comprising elastomer resin, and additives such as dyes or color fixing agents. Preferably, the resin solution comprises acrylate resin or polyurethane resin. In one preferred embodiment of the invention, the acrylate resin comprises polymethacrylate, polymethyl methacrylate or acrylic resin. In another preferred embodiment of the invention, the polyurethane resin comprises organic polyurethane resin or polyurethane dispersion resin. The manner of impregnating or coating is well known to artisans skilled in this field, which is incorporated hereinwith for reference.

In one preferred embodiment of the invention, a washing step and a drying step are performed after the impregnating step in the resin solution. The manner of washing and drying are well known to artisans skilled in this field. In one embodiment of the invention, water is used in washing and extrusion wheels are optionally used. The conditions for washing are well known to artisans skilled in this field. Preferably, the substrate is washed in water and then subjected to the extrusion wheels several times. The conditions for drying are well known to artisans skilled in this field. In one embodiment of the invention, the drying is air-drying. Preferably, the substrate is dried at 90° C. to 170° C., more preferably, 120° C. to 160° C., most preferably, 130° C. to 150° C.

As used herein, the term “polyurethane” collectively means polyurethane, polyurea, polyurethane-polyurea, and the mixture thereof.

The foamed polyurethane dispersion according to the invention is formed by a mechanical or chemical manner. In one preferred embodiment of the invention, the foamed polyurethane dispersion is formed by mechanically stirring a polyurethane dispersion. Through mechanically stirring, air is mixed into the dispersion homogenously. The void content of the foamed polyurethane dispersion according to the invention is easily controlled by adjustably conducting mechanical stirring of the polyurethane dispersion. On the other hand, the foamed polyurethane dispersion can also be formed by using a foaming agent. The content or species of the foaming agent is well known to artisans skilled in this field. Preferably, the foaming agent is selected from the group consisting of sodium bicarbonate, ammonium carbonate, ammonium bicarbonate, sodium borohydride, sodium nitrite, polyvinyl chloride, ethylene vinyl acetate, N-nitroso compounds, azo compounds, sulfonhydrazide, and the mixture thereof.

Solid content of the foamed polyurethane dispersion is unexpectedly found to play an important role in mechanical and chemical properties of the artificial leather. The foamed polyurethane dispersion according to the invention is characterized by having a solid content of about 40% to about 60%. Conventionally, the solid content of polyurethane dissolved in an organic solvent ranges from 10% to 30%. The solid content of the foamed polyurethane dispersion in the present invention is higher than that of polyurethane solution conventionally used. Preferably, the polyurethane dispersion according to the invention has a solid content of about 50% to about 60%, more preferably, about 55%.

In another aspect, void content of the foamed polyurethane dispersion is also unexpectedly found to play an important role in mechanical and chemical properties of the artificial leather, especially in hardness and mechanical properties. The foamed polyurethane dispersion according to the invention is characterized by having a void content of about 0.01% to about 80%, preferably, about 2% to about 65%.

In one preferred embodiment of the invention, the foamed polyurethane dispersion further comprises an additive for mediating its specific functions. Examples of the additive are a dye, a thickener, an antioxidant, a flame-resisting agent, an anti-yellowing agent, an antibiotic, or the mixture thereof. The content or species of the additive is well known to artisans skilled in this field, which is incorporated hereinwith for reference.

The manner of coating the substrate with the foamed polyurethane dispersion is well known to artisans skilled in this field. Examples of coating include direct applying, such as knife-coating and roll-coating. After coating, a layer of the foamed polyurethane dispersion is formed on the surface of the substrate.

The manner of drying the substrate and the layer of the foamed polyurethane dispersion is well known in this field. In one preferred embodiment of the invention, the substrate and the layer of the foamed polyurethane dispersion are dried by heating. The drying step also leads the foamed polyurethane dispersion to cure and form a layer of foamed polyurethane on the surface of the substrate.

A reprocess performed on a surface of the foamed polyurethane layer is preferably desired. The method according to the invention further comprises:(e) post-treating the artificial leather by the step of adhering a layer, stamping, grinding, printing, or spraying on a surface of the artificial leather. Such reprocess achieves different appearance or properties of the surface of the artificial leather. The manner of stamping, grinding, printing, or spraying is well known to in this field, which is incorporated hereinwith for reference.

The method according to the invention avoids the defects of conventional methods of using a toxic solvent, dimethylformamide. The foamed polyurethane dispersion used in the present invention is an aqueous solution and has no harm to the environment or human.

The present invention also provides artificial leather produced according to the method as mentioned above. The artificial leather comprises:
a substrate having a surface; and
a layer of foamed polyurethane formed on the surface of the substrate, comprising a plurality of holes distributed evenly therein, wherein the cross section of the holes is substantially in an ellipse shape; preferably, the holes in an ellipse shape has a diameter of about 20 μm to about 150 μm.

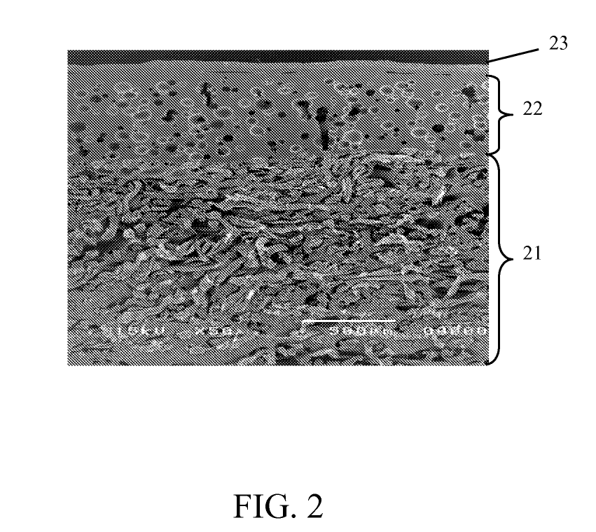

The cross-section view under a scanning electron microscope of one type of the artificial leather according to the present invention is shown in FIG. 2; wherein 21 represents the substrate, 22 represents the foamed polyurethane layer, and 23 represents the adhering layer as described below.

In another aspect, the artificial leather with the foamed polyurethane layer according to the invention comprises a layer attached on a surface of the foamed polyurethane layer on the side opposite to the substrate. The layer is an adhering layer, a printing layer, a spraying layer, etc., depending on the desired application and reprocess involved in the production method. In still another aspect of the invention, the foamed polyurethane layer has a surface having texture thereon. The texture is preferably produced by stamping or grinding.

The artificial leather according to the invention dramatically improves the mechanical and chemical properties thereof as compared to conventional artificial leather. The hole shape and size according to the invention are also improved. The conventional artificial leather has the drop-shaped holes with a length of about 250 to about 350 μm and a width of about 150 to about 320 μm; on the other hand, the artificial leather according to the invention has ellipse holes has a diameter of about 20 μm to about 150 μm. The ellipse shape and smaller size of the holes of the foamed polyurethane layer of the artificial leather according to the invention avoid the defects of folding lines of conventional artificial leather. Furthermore, the mechanical strength (such as peeling, abrasion and flexibility) is improved. It is noted that the peeling strength of the artificial leather according to the invention is above 2.5 kg/cm. No folding lines appear on the foamed polyurethane layer of the artificial leather according to the invention and the surface of the artificial leather is fine and flat. The artificial leather according to the invention has excellent properties and is qualified to replace natural leather in the application of manufacturing shoes, furniture, cloth, and the like.

The following examples are given for the purpose of illustration only and are not intended to limit the scope of the present invention.

### EXAMPLE 1

Substrate. Composite fibers of nylon and polyethylene terephthalate (PET) with a fineness of 3 denier were needle-bonded to form a non-woven fabric substrate. The thickness of the substrate was 2.0 mm and the weight of area unit was 900 g/m².

Substrate Impregnating. An elastomer resin solution comprising 7 wt % polyurethane, 1 wt % dye and 92 wt % dimethylformamide was prepared and the substrate was impregnated, in the elastomer solution.

Substrate Curing. The substrate, after impregnating, was put in water to cure the resin impregnated in the fibers.

Substrate Washing. The residues and the excess water were removed by extrusion wheels. The substrate was then washed in water and then subjected to the extrusion wheels for several times.

Substrate Drying. The substrate, after washing, was then dried.

Substrate Reducing. The substrate was then treated with 5 wt % sodium hydroxide for hydrolyzing the long chain of PET. After removing the excess sodium hydroxide, washing and drying the substrate, the fineness of the fabric was reduced to 0.07 denier.

Coating. The 2.0 mm semi-product was coated with a foamed polyurethane dispersion, formed by mechanically stirring, having a void content of 10%, a foaming density of 0.9 g/cm³ and a solid content of 52%, 0.3 wt % dye, and 5.4 wt % thickener.

Drying. The substrate with the foamed polyurethane dispersion was then dried for removing excess water and forming a layer of the foamed polyurethane on the surface of the substrate.

Reprocessing. A releasing paper with natural leather texture was coated with a polyurethane layer and then further with polyurethane adhesive to form an adhering layer. The surface of the foamed polyurethane layer on the side opposite to the substrate was then adhered with the adhering layer. After curing, the release paper was released to obtain the artificial leather.

### EXAMPLE 2

Substrate. Composite fibers of 60% nylon and 40% polyethylene terephthalate (PET) were needle-bonded to form a non-woven fabric substrate. The thickness of the substrate was 1.0 mm and the weight of area unit was 280 g/m².

Substrate Impregnating. An elastomer resin solution comprising 10 wt % polyurethane dispersion, 3 wt % dye, 2 wt % thickener, and 85 wt % water was prepared and the substrate was impregnated in the elastomer resin.

Substrate Drying. The substrate was then dried to form a semi-product with a thickness of 1.0 mm.

Coating. The semi-product was coated with a foamed polyurethane dispersion having a void content of 15% and a solid content of 52%, 0.3 wt % dye, and 5.4 wt % thickener.

Drying. The substrate with the foamed polyurethane dispersion was then dried for removing excess water and forming a layer of the foamed polyurethane on the surface of the substrate.

Reprocessing. A releasing paper with natural leather texture was coated with a polyurethane layer and then further with polyurethane adhesive to form an adhering layer. The surface of the foamed polyurethane layer on the side opposite to the substrate was then adhered with the adhering layer. After curing, the release paper was released to obtain the artificial leather.

### EXAMPLE 3

Substrate. Single fibers polyethylene terephthalate (PET) were needle-bonded to form a non-woven fabric substrate. The thickness of the substrate was 1.0 mm and the weight of area unit was 330 g/m².

Coating. The semi-product was coated with a foamed polyurethane dispersion having a void content of 15% and a solid content of 52%, 0.3 wt % dye, and 5.4 wt % thickener.

Drying. The substrate with the foamed polyurethane dispersion was then dried for removing excess water and forming a layer of the foamed polyurethane on the surface of the substrate.

Reprocessing. A releasing paper with natural leather texture was coated with a polyurethane layer and then further with polyurethane adhesive to form an adhering layer. The surface of the foamed polyurethane layer on the side opposite to the substrate was then adhered with the adhering layer. After curing, the release paper was released to obtain the artificial leather.

Assay

The appearance, peeling, abrasion and hydrolysis resistance of the artificial leather obtained in Examples 1 to 3 were assayed. The methods and apparatuses for assaying are listed below:

Abrasion: ASTM D3886, CSI Cs-022C S/N-846

Peeling: ASTM D751, Instron 4465

Hydrolysis resistance: ASTM D3690, Firstek scientific Model-B403.

The results are shown in Table 1:

TABLE 1

| | Example 1 | Example 2 | Example 3 | Conventional |
|---|---|---|---|---|
| Appearance | thick and | thick and | thick and | thin and weak |
| | strong | strong | strong | |
| Folding lines | none | Mild | mild | deep |
| Peeling | 2.5 kg/cm up | 2.5 kg/cm up | 2.5 kg/cm up | 1.6 kg/cm |
| Abrasion | 3500+ | 2920+ | 3500+ | 1750+ |
| Hydrolysis | 1 week up | 1 week up | 1 week up | 2 days |
| resistance | | | | |

While embodiments of the present invention have been illustrated and described, various modifications and improvements can be made by persons skilled in the art. The embodiments of the present invention are therefore described in an illustrative but not restrictive sense. It is intended that the present invention is not limited to the particular forms as illustrated, and that all the modifications not departing from the spirit and scope of the present invention are within the scope as defined in the appended claims.

1. A method of producing artificial leather, comprising steps of:
(a) providing a substrate;
(b) providing a foamed polyurethane dispersion, wherein the polyurethane dispersion has a solid content of about 40% to about 60% and a void content of about 0.01% to about 80%;
(c) coating the substrate with a layer of the foamed polyurethane dispersion; and
(d) drying the substrate and the layer of the foamed polyurethane dispersion for obtaining the artificial leather.

2. The method according to claim 1, wherein the substrate is pretreated by impregnating or coating the substrate with a resin solution comprising acrylate resin or polyurethane resin.

3. The method according to claim 2, wherein the acrylate resin comprises polymethacrylate, polymethyl methacrylate or acrylic resin.

4. The method according to claim 2, wherein the polyurethane resin comprises organic polyurethane resin or polyurethane dispersion resin.

5. The method according to claim 1, wherein the polyurethane dispersion has a solid content of 50% to 60%.

6. The method according to claim 1, wherein the polyurethane dispersion as a solid content of about 55%.

7. The method according to claim 1, wherein the polyurethane dispersion has a void content of about 2% to about 65%.

8. The method according to claim 1, wherein the foamed polyurethane dispersion further comprises a dye, a thickener, an antioxidant, a flame-resisting agent, an anti-yellowing agent, an antibiotic, or the mixture thereof.

9. The method according to claim 1, wherein the foamed polyurethane dispersion is formed by mechanical stirring.

10. The method according to claim 1, wherein the foamed polyurethane dispersion is formed by using a foaming agent.

11. The method according to claim 10, wherein the foaming agent is selected from the group consisting of sodium bicarbonate, ammonium carbonate, ammonium bicarbonate, sodium borohydride, sodium nitrite, polyvinyl chloride, ethylene vinyl acetate, N-nitroso compounds, azo compounds, sulfonhydrazide, and the mixture thereof.

12. The method according to claim 1, wherein the substrate and the foamed polyurethane dispersion are dried by heating.

13. The method according to claim 1, which further comprises:
(e) post-treating the artificial leather by the step of adhering a layer, stamping, grinding, printing, or spraying on a surface of the artificial leather.

14-20. (canceled)
